(19) United States
(12) Patent Application Publication
(10) Pub. No.: US 2015/0035711 A1
(43) Pub. Date: Feb. 5, 2015

(54) ELECTRONIC DEVICE AND CONTROL METHOD THEREOF

(71) Applicant: KABUSHIKI KAISHA TOSHIBA, Tokyo (JP)

(72) Inventor: Naoto Ito, Mitaka-shi (JP)

(21) Appl. No.: 14/311,618

(22) Filed: Jun. 23, 2014

(30) Foreign Application Priority Data
Jul. 31, 2013 (JP) 2013-159640

(51) Int. Cl. H01Q 9/04

(52) U.S. Cl. CPC H01Q 9/0442
USPC 343/745

(57) ABSTRACT

According to at least one embodiment, an electric device, includes a first housing, a second housing, a proximity wireless communication module, an antenna, a detector, and a reactance adjustment circuit. The first housing includes a display. The second housing includes a keyboard including a plurality of keys. The antenna is connected to the proximity wireless communication module. The detector detects whether or not the keyboard is capable of receiving a code from the plurality of keys and outputs a signal corresponding to the detection result. The reactance adjustment circuit adjusts a reactance of the antenna according to the signal.

### CROSS-REFERENCE TO RELATED APPLICATIONS

This application is based upon and claims the benefit of priority from Japanese Patent Application No. 2013-159640, filed Jul. 31, 2013, the entire contents of which are incorporated herein by reference.

### FIELD

Embodiments described herein relate generally to an electronic device and control method thereof.

### BACKGROUND

Recently, as personal computers have diversified, a convertible personal computer and a detachable personal computer are being marketed for sale that are capable of having a configuration (form) corresponding to either a notebook computer or a tablet computer.

Also, a personal computer comprising near-field communication equipment such as Felica (registered trademark), ISO/IEC 14443 (MIFARE [registered trademark]), ISO/IEC 18092, ISO/IEC 2148, TransferJet (registered trademark) has been recently developed.

It is suggested to install near-field communication equipment in a computer that is capable of having a plurality of forms such as a convertible personal computer and a detachable personal computer.

Regarding a computer that is capable of having a plurality of forms, a reactance differs according to a form in a resonant circuit including a radio and an antenna used for near-field communication. Since a reactance differs according to a form, a resonant frequency differs according to a form.

Since the size of an antenna is small for frequency, the Q of a resonant circuit is high. Since the Q is high, the resonant characteristic of a resonant circuit is narrowband.

Since a circuit frequency differs according to a form and the resonant characteristic of a resonant circuit is narrowband, a resonant frequency is distant from a desired resonant frequency in certain forms. This makes a communicable area narrow.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a drawing illustrating an appearance corresponding to a notebook mode and a tablet mode of an electric device according to an embodiment.

FIG. 2 is a drawing illustrating the relationship between a base unit and a display unit in the electronic device according to the embodiment.

FIG. 3 is a block diagram illustrating a system configuration of the electronic device according to the embodiment.

FIG. 4 is a diagram illustrating a configuration of a reactance component adjustment circuit.

FIG. 5 is a graph illustrating a resonant frequency of an antenna when the reactance component of the antenna is unchanged.

FIG. 6 is a flowchart illustrating a procedure of adjusting a reactance component according to the embodiment.

FIG. 7 is a drawing illustrating an appearance corresponding to the notebook mode and the tablet mode of the electric device according to the embodiment.

### DETAILED DESCRIPTION

Various embodiments will be described hereinafter with reference to the accompanying drawings.

In general, according to one embodiment, an electric device, comprises a first housing, a second housing, a proximity wireless communication module, an antenna, a detector, and a reactance adjustment circuit. The first housing comprises a display. The second housing comprises a keyboard comprising a plurality of keys. The antenna is connected to the proximity wireless communication module. The detector is configured to detect whether or not the keyboard is capable of receiving a code from the plurality of keys and to output a signal corresponding to the detection result. The reactance adjustment circuit is configured to adjust a reactance of the antenna according to the signal.

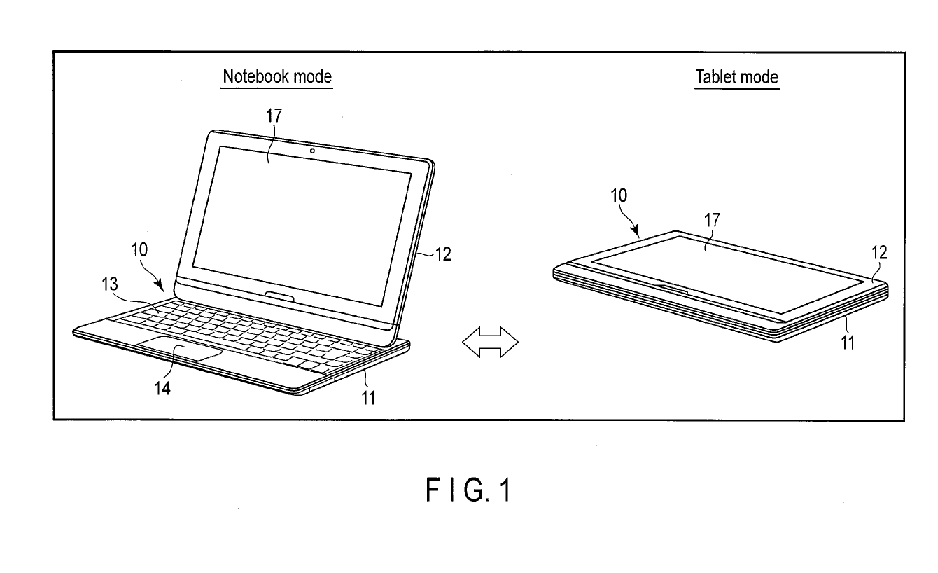

FIG. 1 is a drawing illustrating an appearance corresponding to a notebook mode and a tablet mode of an electric device according to an embodiment. The electronic device is realized as, for example, a convertible computer 10. The convertible computer 10 is used in a style corresponding to either the notebook mode as shown on the left in FIG. 1 or the tablet mode as shown on the right in FIG. 1.

The convertible computer 10 comprises a base unit 11 and a display unit 12. The base unit 11 has a thin rectangular housing that accommodates a CPU, a memory, various types of electronic parts, and the like. A keyboard 13 and a touchpad 14, which is a pointing device, are arranged on the top surface of the base unit 11. The touchpad 14 is arranged in a palm rest region on the top surface of the base unit 11.

A display 17 is arranged on the front surface of the display unit 12, i.e., on the display surface of the display unit 12. The display 17 is realized by a touchscreen display that is capable of detecting the location of a stylus or a finger on the screen of the display 17.

The display unit 12 is placed either in a first position corresponding to a style of the notebook mode shown on the left in FIG. 1 or in a second position corresponding to a style of the tablet mode shown on the right in FIG. 1. In more detail, the display unit 12 is placed either in the first position (notebook mode) in which the display surface of the display unit 12 and the top surface of the base unit 12 are exposed, or in the second position (tablet mode) in which the display surface of the display unit 12 is exposed and the top surface of the base unit 11 is covered by the back surface of the display unit 12.

In the notebook mode, the convertible computer 10 is used mainly in a state of being placed on a horizontal surface such as on a desk. The user operates the keyboard 13, as with a normal notebook computer.

On the other hand, in the tablet mode, the convertible computer 10 is used in a state of being held by the user in one hand or in two hands. The user holds the convertible computer 10, for example, in one arm, and uses the other arm to touch and operate on the display 17.

The keyboard 13 has a plurality of keys. In the notebook mode, it is possible to input in the CPU codes corresponding to the respective keys in the keyboard 13 by using the keyboard 13. On the other hand, in the tablet mode, it is not possible to input in the CPU a code corresponding to a key in the keyboard 13 by using the keyboard 13.

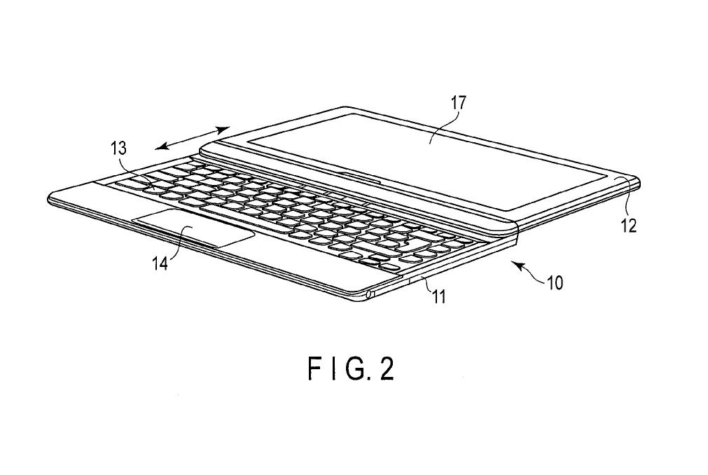

FIG. 2 is a drawing illustrating an example of the relationship between the base unit 11 and the display unit 12. The display unit 12 is attached to a supporting member (hinge) arranged on the rear end of the base unit 11 so that the display surface is almost parallel to the top surface of the base unit 11, i.e., open almost 180 degrees. Further, the display unit 12 is attached to the base unit 11 slidably between the front end and the rear end.

Various mechanisms can be used for a mechanism to slide the display unit 12. For example, a guiderail (gap) extending from the bottom end to the top end of the display unit 12 may be arranged to the back surface of the display unit 12. Further, the supporting member (hinge) of the rear end of the base unit 11 may be slidably engaged to the guiderail. When the display unit 12 opens almost 180 degrees, it is possible to slide the display unit 12 between the front end and the rear end of the base unit 11 in line with the guiderail of the back surface of the display unit 12.

In FIG. 2, by sliding the display unit 12 to the front end of the base unit 11 so that the bottom end of the display unit 12 reaches the front end of the base unit 11, it is possible to set the computer 10 to the tablet mode. Also, in FIG. 2, by lifting the top end of the display unit 12 to stand the top end of the display unit 12, it is possible to set the computer 10 to the notebook mode.

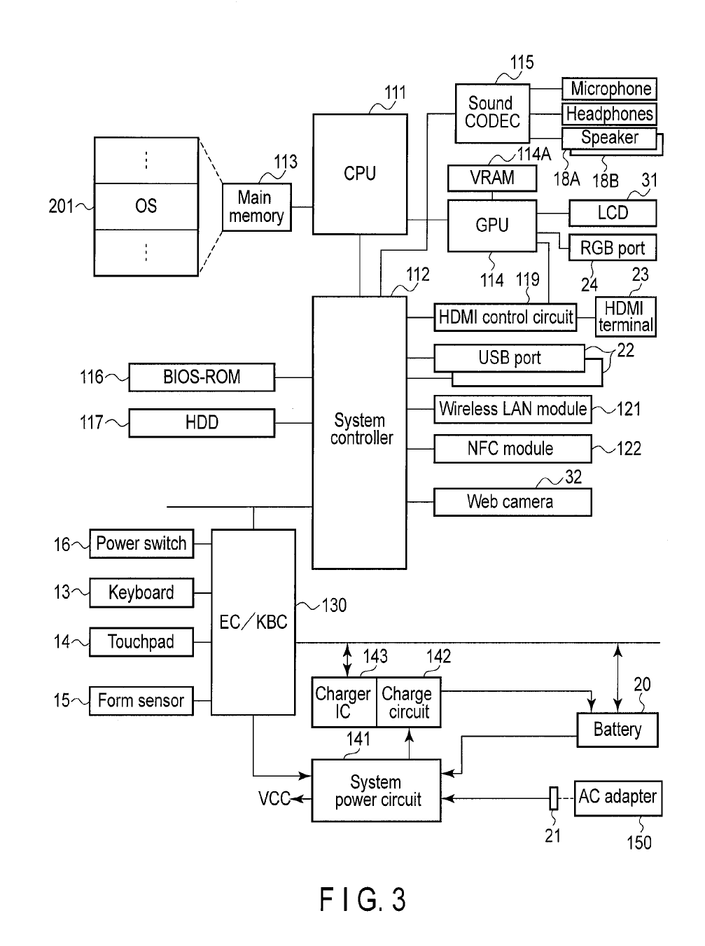

FIG. 3 illustrates a system configuration of the personal computer 10 of the embodiment. The personal computer 10 comprises a CPU 111, a system controller 112, a main memory 113, a graphics processing unit (GPU) 114, a sound codec 115, a BIOS-ROM 116, a hard disk drive (HDD) 117, a wireless LAN module 121, an NFC module 122, an embedded controller/keyboard controller IC (EC/KBC) 130, a system power circuit 141, a charge circuit 142, a charger IC 143, and the like.

The CPU 111 is a processor to control the operation of each component of the personal computer 10. The CPU 111 executes various types of programs loaded from the HDD 117 to the main memory 113. The program includes the operating system (OS) 201 and various types of application programs.

Also, the CPU 111 executes a basic input/output system (BIOS) stored in the BIOS-ROM 116, which is a non-volatile memory. The BIOS is a system program to control hardware.

The GPU 114 as a graphic processor is a display controller that controls an LCD 31 used as a display monitor of the personal computer 10. The GPU 114 generates a display signal (LVDS signal) that should be supplied to the LCD 31 from the display data stored in a video memory (VRAM) 114A. Further, the GPU 114 is capable of generating an analogue RGB signal and an HDMI (registered trademark) video signal from the display data. The analogue RGB signal is supplied to an external display via an RGB port 24. An HDMI output terminal 23 is capable of transmitting to the external display by a cable an HDMI video signal (incompressible digital video signal) and a digital audio signal. The HDMI control circuit 119 is an interface to transmit an HDMI video signal and a digital audio signal to the external display via the HDMI output terminal 23.

The system controller 112 is a bridge device that connects between the CPU 11 and each component. A serial ATA controller to control the hard disk drive (HDD) 117 is built into the system controller 112.

Also, the system controller 112 comprises devices such as a USB port 22, the wireless LAN module 121, the NFC module 122 and a Web camera 32. The NFC module 122 is a wireless application that performs near-field communication such as Felica, ISO/IEC 14443 (MIFARE), ISO/IEC 18092, ISO/TEC 2148 and TransferJet.

Further, the system controller 112 executes communication with each device that is connected via a bus.

The EC/KBC 130 is connected to the system controller 112 via a bus. Also, the EC/KBC 130 is mutually connected to the charger IC 143 and a battery 20 via a serial bus.

The EC/KBC 130 is a power management controller to execute power management of the personal computer 10. For example, the EC/KBC 130 is realized as a single-chip control microcomputer in which a keyboard controller to control the keyboard (KB) 13 and the touchpad 14 is built. The EC/KBC 130 has a function to turn on and turn off the personal computer 10 according to a user's operation of a power switch 16. The control of turning on and turning off the personal computer 10 is executed by the EC/KBC 130 to the system power circuit 141.

The charger IC 143 is an IC that controls the charge circuit 142 under the control of the EC/KBC 130. The EC/KBC 130, the charger IC 143 and the system power circuit 141 are operated by power from the battery 20 or an AC adapter 150, even when the personal computer 10 is turned off.

The system power circuit 141 uses power from the battery 20 or power from the AC adapter 150 that is connected to the base unit 11 as an external power to generate power (operation power source) that should be supplied to each component. Also, the system power circuit 141 supplies power to charge the battery 20 by the charger circuit 142.

The charge circuit 142 charges to the battery 20 power that is supplied through the system power circuit 141 by control of the charger IC 143.

A form sensor 15 detects a form of a computer. That is, the form sensor 15 detects whether the computer 10 is in the notebook mode or in the tablet mode.

As the surrounding structure of an NFC antenna 122A differs by each form, a resonant frequency changes. The computer 10 detects a mode of the computer 10 by a mode sensor and adjusts the reactance component of an antenna according to the detection result, to thereby inhibit a change in a resonant frequency by a mode.

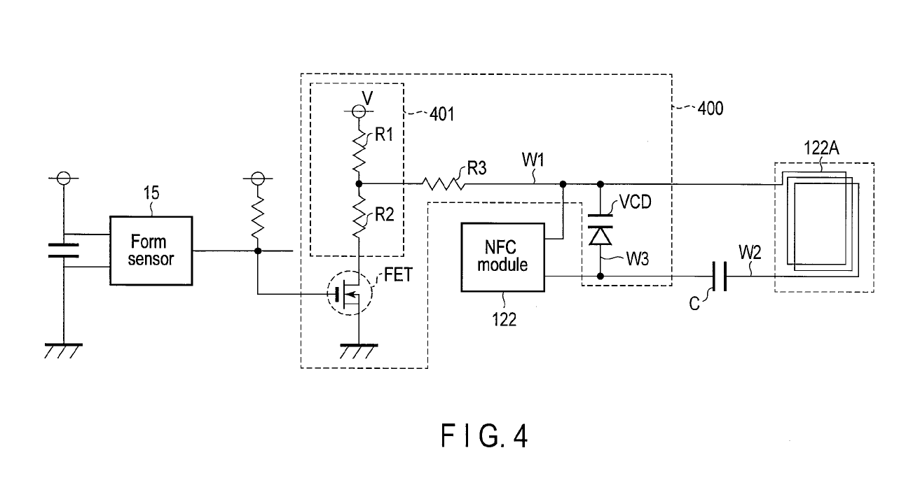

FIG. 4 is a diagram illustrating a configuration of a reactance component adjustment circuit.

A reactance component adjustment circuit 400 includes a field-effect transistor FET, a voltage adjustment circuit 401 and a varicap diode (variable capacitance diode) VCD.

The field-effect transistor FET as a switching element is turned on or turned off according to output from the form sensor 15. The voltage adjustment circuit 401 supplies either a first voltage or a second voltage to the varicap diode VCD according to a state of the field-effect transistor FET.

A voltage source V is connected to the end of a resistance R₁. The end of a resistance R₂ is connected to the other end of the resistance R₁. The drain of the field-effect transistor FET is connected to the other end of the resistance R₂. An earth is connected to the source of the field-effect transistor FET. The output of the form sensor 15 is input to the gate electrode of the field-effect transistor FET.

The end of a wiring W1 is connected between the other end of the resistance R₁ and the end of the resistance R2. A resistance R3 is inserted to the wiring W1. The end of the NFC antenna 122A is connected to the other end of the wiring W1. The other end of the NFC antenna 122A is connected to the end of the wiring W2. A capacitor is inserted into the wiring W3. The other end of the wiring W2 is connected to the NFC module 122. The W1 is connected to the NFC module 122. The end of the wiring W3 is connected to the wiring W1. The other end of the wiring W3 is connected to the wiring W2. The varicap diode (variable capacitance diode) VCD is inserted into the wiring W3. The varicap diode VCD and the NFC antenna 122A are connected in parallel.

In the tablet mode, the field-effect transistor FET is turned off, a voltage V [v] is applied to the varicap diode VCD, and a resonant frequency decreases as the capacitance of the antenna 122A increases. In the notebook mode, the field-effect transistor FET is turned on, a voltage {R₂/(R₁+R₂)}×V (V [V] or less) divided into the resistance R₁ and the resistance R₂ is applied to the varicap diode VCD, and a resonant frequency increases as the capacitance of the antenna 122A decreases. If an inverter is structured at the field-effect transistor FET, it is possible to invert the behavior of frequency variability in the tablet mode and the notebook mode. Also, it is possible to adjust voltage applied to the varicap diode VCD at the resistance R₁/R₂.

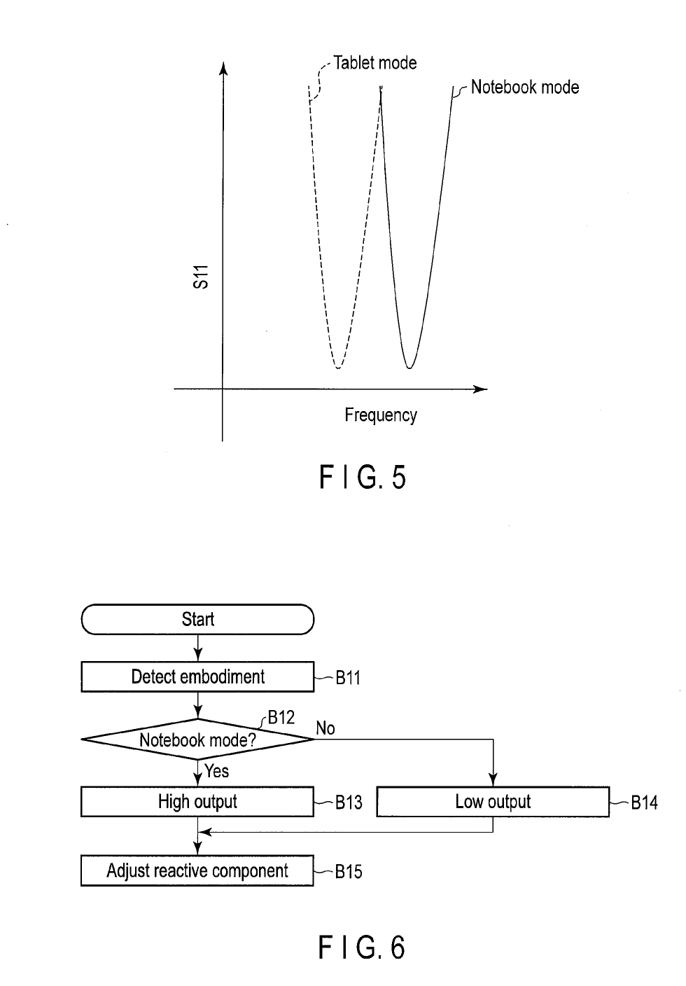

FIG. 5 shows a resonant frequency of an antenna when the reactance component of the antenna is unchanged. As shown in FIG. 5, if the reactance component of an antenna is unchanged, the resonant frequency of an antenna in the notebook mode is different from the resonant frequency of an antenna in the tablet book mode.

FIG. 6 is a flowchart illustrating a procedure of adjusting the reactance component of the form.

The form sensor 15 detects the form of a computer (block B11). If the form is in the notebook mode (block B12, Yes), the form sensor 15 output goes high (block B13). If the form is not in the notebook mode (block B12, No), the form sensor 15 output goes low (block B14). The reactance component adjustment circuit 400 adjusts a reactance component according to a signal from the form sensor 15 (block B15).

As in the present embodiment, by detecting a mode (form) of a computer, outputting a signal according to the detection result, and adjusting the reactance component of an antenna according to a signal by a reactance adjustment circuit, the difference in a resonant frequency according to a mode (form) is inhibited so that a communicable region is widened or gets easier to communicate.

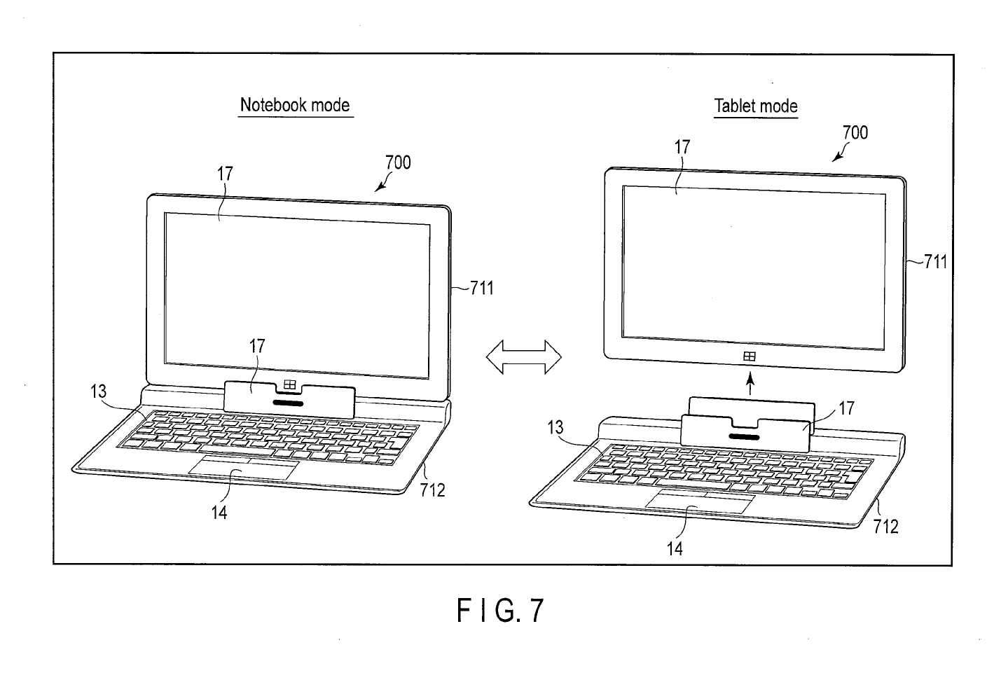

FIG. 7 is a perspective view illustrating a configuration of a detachable computer.

FIG. 7 shows an appearance corresponding to a notebook mode and a tablet mode of an electronic device of an embodiment. The electronic device is realized as, for example, a detachable computer 700. The detachable computer 700 is used in a style corresponding to either of the notebook mode shown on the left in FIG. 1 or the tablet mode shown on the right in FIG. 1.

The detachable computer 700 comprises a tablet unit 711 and a keyboard unit 712. The base unit 11 comprises a thin rectangular housing that accommodates a CPU, a memory, a display, a GPU, various types of electronic parts, and the like. The keyboard unit 712 comprises a keyboard, a touchpad, a hinge, and the like.

The tablet unit 711 is attachable to the keyboard unit 712. The tablet unit 711 is attachable to a hinge arranged on the keyboard unit 712. If the tablet unit 711 is attached to the hinge, the electronic device is used in the notebook mode. If the tablet unit 711 is not attached to the hinge, the electronic device is used in the tablet mode.

The display 17 is arranged on the front surface of the tablet unit 711, i.e., the display surface of the tablet unit 711. The display 17 is realized by a touchscreen display that is capable of detecting the position of a stylus or a finger on the screen of the display 17.

The keyboard 13 and the touchpad 14, which is a pointing device, are arranged on the top surface of the keyboard unit 712. The touchpad 14 is arranged in a palm rest region on the top surface of the keyboard unit 712.

It should be noted that in the notebook mode, the tablet unit 711 is attached to a hinge rotatably between an opening position in which the top surface of the keyboard unit 712 is exposed and a closing position in which the top surface of the keyboard unit 712 is covered by the display surface of the tablet unit 711.

It should also be noted that an antenna is arranged in the tablet unit 711. In the notebook mode, an antenna is arranged, for example, in a position adjacent to the keyboard unit 712.

A reactance component may be adjusted according to installation location, not to an form of a computer. For example, if metal exists in the vicinity of a computer, a capacitance changes in a resonant circuit containing an antenna. The reactance component of the antenna may be adjusted according to the detection result of a metal detector by installing a metal detector.

By detecting a form of a computer, outputting a signal according to the detected form and adjusting the reactance component of the antenna according to output signal, it becomes possible to prevent the communicable area of near-field communication from being narrowed regardless of form.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electric device, comprising:
a first housing comprising a display;
a second housing comprising a keyboard comprising a plurality of keys;
a proximity wireless communication module;
an antenna connected to the proximity wireless communication module;
a detector configured to detect whether or not the keyboard is capable of receiving a code from the plurality of keys and to output a signal corresponding to the detection result; and
a reactance adjustment circuit configured to adjust a reactance of the antenna according to the signal.

2. The device of claim 1, wherein the reactance adjustment circuit comprises;
a varicap diode connected in parallel with the antenna;
a switching element configured to be set in an on state or an off state according to the signal; and
a voltage adjustment circuit configured to supply either a first voltage or a second voltage to the varicap diode according to a state of the switching element.

3. The device of claim 1, wherein the antenna is in the first housing.

4. The device of claim 1, wherein the antenna is in the second housing.

5. An electric device, comprising a first housing comprising a display, and a second housing comprising a keyboard comprising a plurality of keys, wherein the second housing is attachable to the first housing, the device comprising:
a proximity wireless communication module;
an antenna connected to the proximity wireless communication module;
a detector configured to detect whether the second housing is attached to the first housing and to output a signal according to the detection result; and
an adjustment module configured to adjust a reactance component of the antenna according to the signal.

6. The device of claim 5, wherein the antenna is in the first housing.

7. The device of claim 5, wherein the first housing is attached to a hinge on the second housing.

8. A control method of an electric device comprising a first housing comprising a display, a second housing comprising a keyboard comprising a plurality of keys, a proximity wireless communication module, and an antenna connected to the proximity wireless communication module, the method comprising:
detecting whether or not the keyboard is capable of receiving a code from the plurality of keys;
outputting a signal according to the detection result; and
adjusting a reactance of the antenna according to the signal.
